(19) United States
(12) Patent Application Publication
(10) Pub. No.: US 2008/0167191 A1
(43) Pub. Date: Jul. 10, 2008

(54) Superconducting filter device and filter characteristic tuning method

(75) Inventors: Keisuke Sato, Kawasaki (JP); Masao Kondo, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/984,904

(22) Filed: Nov. 26, 2007

(30) Foreign Application Priority Data
Jan. 9, 2007 (JP) 2007-001020

(51) Int. Cl. H01P 1/20

(52) U.S. Cl. 505/210; 333/197

(57) ABSTRACT

A superconducting filter device includes a dielectric base, a resonator pattern formed of a superconducting material on the dielectric base, an anisotropic dielectric or magnetic body positioned over the resonator pattern, and an angle adjusting mechanism for changing a horizontal angle of the anisotropic dielectric or magnetic body with respect to an input signal.

### TECHNICAL FIELD

The present invention relates in general to a superconducting filter device, and more particularly, to a superconducting tunable filterwith a simple structure for tuning the resonance frequency and/or bandwidth.

### BACKGROUND

Along with the rapid development and spread of mobile phones in recent years, high-speed and high-volume data transmission technologies have become indispensable. Because of extremely small surface resistances even at high frequencies, as compared with typical good conductors, superconductors have great potential for application to RF filters used in base stations of mobile communications systems, and application to low-loss and high-Q resonators are especially expected.

When applied to mobile communications, the superconducting filter has to be furnished with a frequency tuning capability. The mainstream technique for tuning frequencies is to control the effective magnetic permeability or the effective permittivity of a superconducting interconnection line. One of known techniques for controlling the effective permittivity of a superconducting pattern is to place a dielectric block on the superconducting pattern and apply a voltage to the dielectric block to change the permittivity. See, for example, G. Subramanyam, et al., “Design and development of ferroelectric tunable HTS microstrip filters for Ku- and K-band applications”, Materials Chemistry and Physics 79 (2003) 147-150.

However, since the permittivity is controlled by applying an electric voltage directly to the dielectric block, there are problems that the transmission loss increases due to degradation of the dielectric block and that high voltage must be applied change the permittivity.

### SUMMARY OF INVENTION

In one aspect of the invention, a superconducting filter device is provided, which device includes:

a dielectric base;

a resonator pattern formed of a superconducting material on the dielectric base;

an anisotropic dielectric or magnetic body positioned over the resonator pattern; and

a mechanism for changing the angle of the anisotropic dielectric or magnetic body with respect to an input signal.

In another aspect of the invention, a method for tuning a superconducting filter device is provided. This method includes the steps of:

placing an anisotropic dielectric or magnetic body over a resonator pattern of the superconducting filter device; and

changing the angle of the anisotropic dielectric or magnetic body with respect to the input signal to control the resonance frequency and/or the bandwidth of the input signal being filtered.

### BRIEF DESCRIPTION OF THE DRAWINGS

Other objects, features, and advantages of the present invention will become more apparent from the following detailed description when read in conjunction with the accompanying drawings, in which:

FIG. 1A and FIG. 1B are schematic diagrams illustrating an example of a superconducting filter device according to an embodiment of the invention;

FIG. 2 illustrates an example of changing the angle or orientation of a permittivity-anisotropic block with respect to the input signal;

FIG. 3A illustrates an example of piezo driving pulse used in an angle adjusting mechanism, and FIG. 3B and FIG. 3C are schematic diagrams illustrating the motion of the angle adjusting mechanism under the application of the piezo driving pulse;

FIG. 4 is a schematic diagram of a model used in characteristic simulation of the superconducting filter device shown in FIG. 1;

FIG. 5A and FIG. 5B are graphs of the simulation results using the model shown in FIG. 4; and

FIG. 6A and FIG. 6B are graphs of the magnetization process of an antiferromagnet, which is an example of the anisotropic magnetic body.

### DESCRIPTION OF EMBODIMENTS

The preferred embodiments of the invention are now described in conjunction with the attached drawings. The figures and the description are presented for illustrative purposes, and do not limit the scope of the invention. Other alternatives and modifications are included within the scope of the invention as long as such alternatives and modifications are consistent with the gist of the invention.

First, explanation is made of the basic idea of the embodiments. An anisotropic dielectric or magnetic body (i.e., a permittivity-anisotropic dielectric substance or a permeability-anisotropic magnetic substance) is positioned over (on or above) a superconducting resonator. The angle or the orientation of the anisotropic dielectric or magnetic body is changed with respect to the input signal such that the permittivity or the magnetic permeability for the input signal varies. With this simple structure, the resonance frequency and/or the bandwidth of the filter device can be controlled efficiently.

A supporting rod or any other supporting means may be used to hold the anisotropic dielectric or magnetic body over the resonator pattern. In this case, a raising/lowering mechanism may be combined with a rotating mechanism, which mechanisms are connected to the supporting rod to change the angle of the dielectric or magnetic body with respect to the input signal and/or the gap between the resonator pattern and the dielectric or magnetic body.

It is unnecessary with this arrangement to apply an external electric or magnetic field to the superconducting filter device to control the filter characteristics. Consequently, an undesirable increase of transmission loss due to degradation of the filter device caused by an externally applied field can be prevented.

Fine tuning of the resonance frequency and/or the bandwidth of the superconducting resonator filter can be achieved simply by changing the orientation of the anisotropic-dielectric or magnetic body with respect to the input signal.

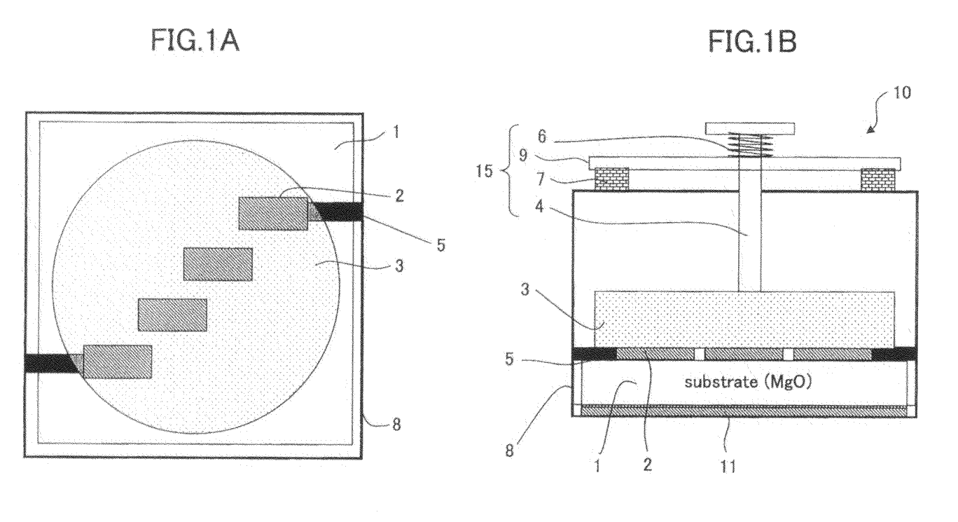

FIG. 1A and FIG. 1B illustrate an example of the structure of a superconducting filter device 10 in a horizontal cross-sectional view and a vertical cross-sectional view, respectively, according to an embodiment of the invention.

In this example, the superconducting filter device 10 is accommodated in a metal package 8 for application as a transmission filter used in a mobile communication system. The superconducting filter 10 includes a dielectric base (such as a single-crystal MgO substrate) 1, a resonator pattern 2 made of a superconductive material and formed in a prescribed shape on the surface of the dielectric base 1, and signal input/output lines 5 extending to and from the vicinity of the superconducting resonator pattern 2. The superconducting filter device 10 also includes an anisotropic dielectric or magnetic block 3 placed over the resonator pattern 2 on the dielectric base 1, and an angle adjusting mechanism 15 for changing the angle or the orientation of the anisotropic dielectric or magnetic block 3 with respect to the input signal. The anisotropic dielectric or magnetic block 3 is a permittivity-anisotropic or permeability-anisotropic block. In the example shown in FIG. 1, the angle adjusting mechanism 15 rotates the anisotropic dielectric or magnetic block 3 to change the angle or the orientation with respect to the input signal.

The superconducting resonator pattern 2 is made of YBCO (Y—Ba—Cu—O) as an example of the superconductive material, and shaped in a microstrip line. The dielectric base 1 is made of a MgO single crystal substrate or any suitable dielectric material having a specific permittivity (dielectric constant) of 8-10 in the frequency range of 3-5 GHz. One of the signal input/output lines 5 is used as a signal input line and the other is used as a signal output line. The bottom face of the dielectric base 1 is covered with a ground electrode (film) 11.

The angle adjusting mechanism 15 includes a piezoelectric element 7, a driving plate 9, a supporting rod 4 extending from the displacement plate 9 to the internal space of the package 8, and a spring 6 for pressing the driving plate 9 against the piezoelectric element 7. The displacement of the piezoelectric element 7 is conveyed as a torque through the driving plate 9 to the supporting rod 4.

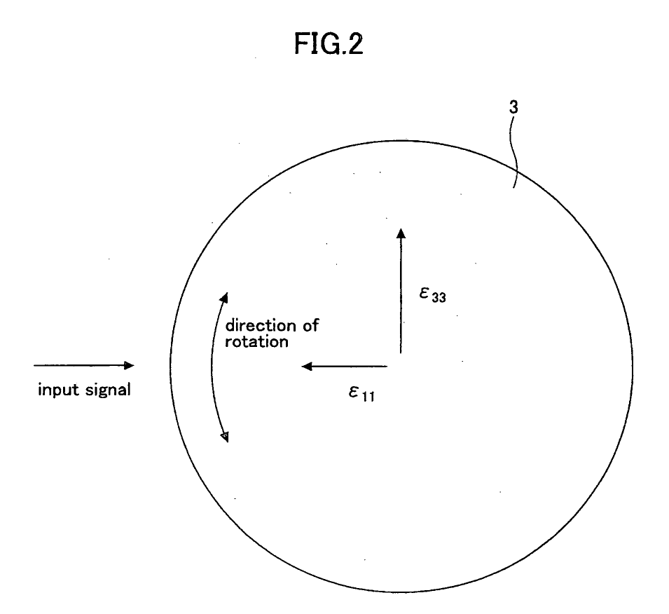

The anisotropic dielectric (or magnetic) block 3 is fixed to the supporting rod 4. Along with the rotation of the supporting rod 4, the anisotropic dielectric block 3 rotates as indicated by the bidirectional arrow, as illustrated in FIG. 2. In this example, the permittivity-anisotropic dielectric block 3 is used. Since the permittivity ∈ᵢⱼ varies depending on the direction, the permittivity for the input signal changes as the supporting rod 4 rotates. As the permittivity decreases, the resonance frequency shifts to a higher range. As the permittivity increases, the resonance frequency shifts to a lower range. By controlling the permittivity with respect to the input signal, the resonance frequency and/or the bandwidth of the superconducting resonator filter 10 can be adjusted, as described below. The anisotropic dielectric block 3 may be made of single-crystal LiNbO3, LiTaO3, BaB2O4, YbO4, TiO2, CaCO3, KTiOPO4, LiB3O5, KH2PO4, LiIO3, sapphire, or other suitable materials. In place of the single crystal material, a polarized poly-crystalline material may be used.

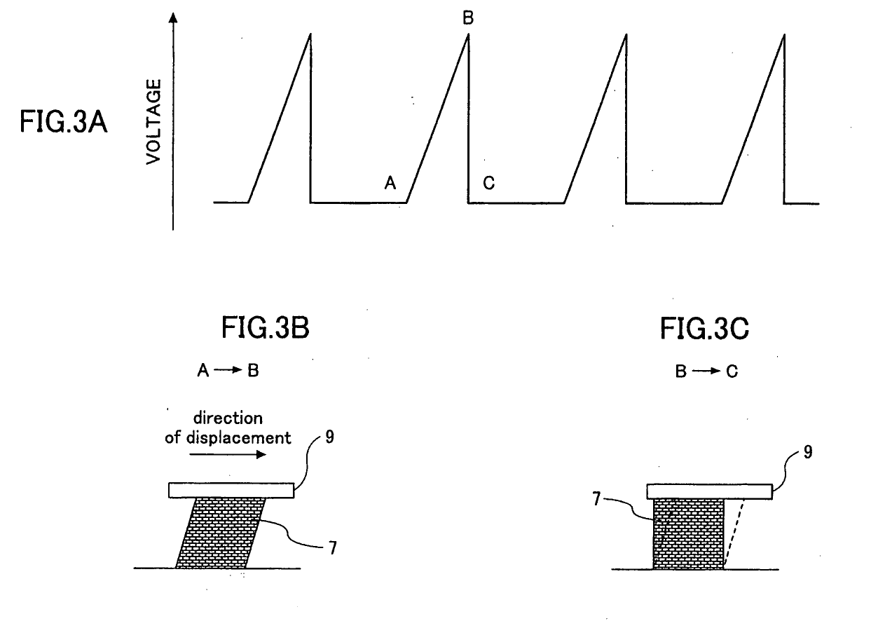

FIG. 3A through FIG. 3C are schematic diagrams for explaining the rotating mechanism using a piezoelectric element 7. As illustrated in FIG. 3A, a sawtooth pulse is applied to the piezoelectric element 7. From A to B of the sawtooth pulse, the applied voltage is increased over a predetermined period of time such that the driving plate 9 moves to a certain position along with the displacement of the piezoelectric element 7, as illustrated in FIG. 3B. When the applied voltage reaches the level B, the voltage applied to the piezoelectric element 7 is brought straight down. The voltage drop from B to C in FIG. 3A is so steep that the pulse shape becomes a sawtooth. Because of the steep voltage drop, the force restoring the piezoelectric element 7 back to the original position (shape) overcomes the frictional force between the piezoelectric element 7 and the driving plate 9, and the piezoelectric element 7 solely returns to the original position, while the driving plate 9 is left at the displaced position, as illustrated in FIG. 3C. By repeating the process, the driving plate 9 rotates in a certain direction. To rotate the driving plate 9 in the opposite direction, an inverse voltage is applied to the piezoelectric element 7.

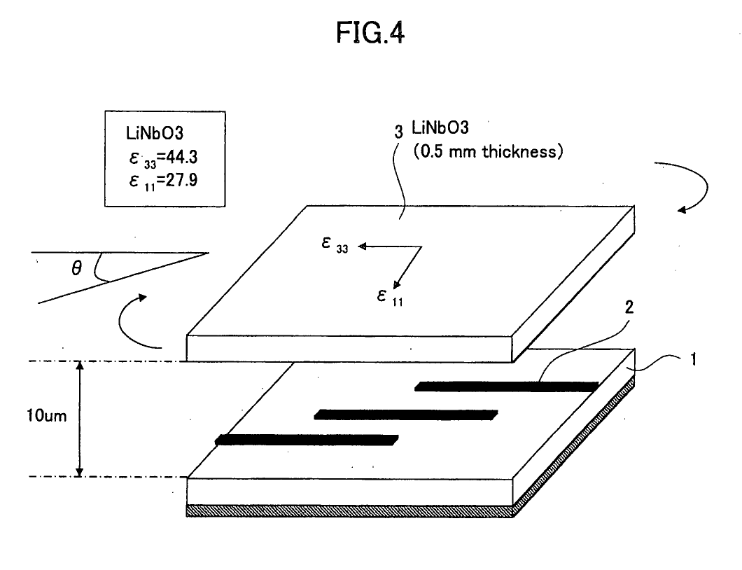

FIG. 4 is a schematic diagram illustrating a model used for simulation of resonance frequency tuning of the superconducting resonator filter of the embodiment. A single-crystal LiNbO3 substrate with a thickness of 0.5 mm is used as the anisotropic dielectric block 3. The diagonal component ∈₁₁ of the permittivity of LiNbO3 is 27.9, and another diagonal component ∈₃₃ is 44.3.

The LiNbO3 substrate is placed above the dielectric base 1 with a separation of 10 μm from the superconducting resonator pattern 2 formed on the dielectric base 1. The LiNbO3 substrate is rotated in a horizontal plane parallel to the superconducting resonator pattern 2, and the transmission characteristic is simulated.

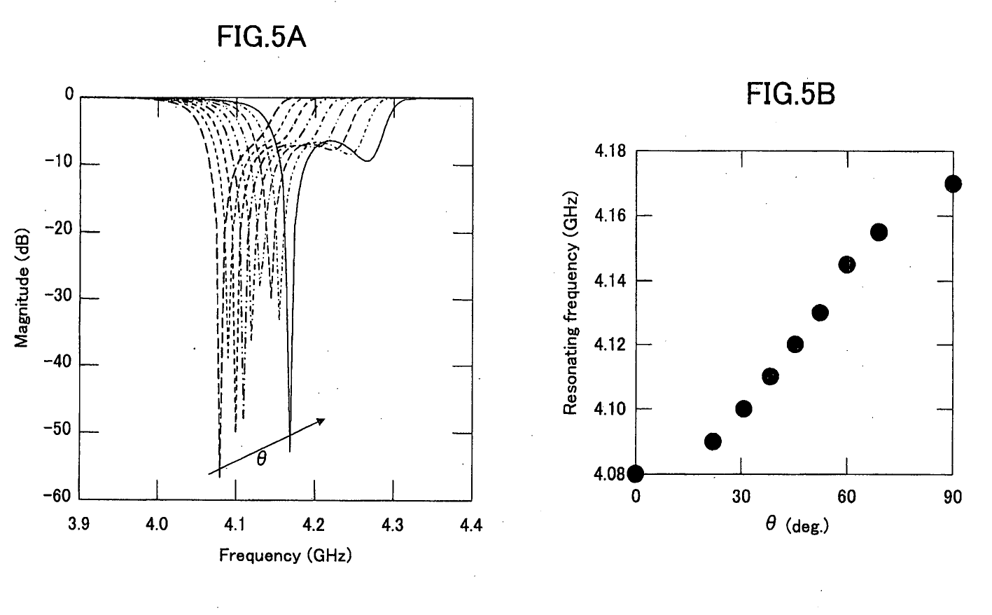

FIG. 5A and FIG. 5B are graphs showing the simulation results. FIG. 5A represents the transmission characteristic at various angles θ when the rotation angle of the driving plate 9 is changed in the range from 0° to 90°. FIG. 5B represents the angle dependency of the resonance frequency. It is understood from the graphs that resonance frequency can be tuned by about 2% when a single-crystal LiNbO3 is used as the anisotropic dielectric block 3. In addition, it is understood from FIG. 5A that fine tuning can be achieved not only in the resonance frequency, but also in the bandwidth.

In the simulation, only the horizontal rotation angle of the anisotropic dielectric block 3 is changed with respect to the input signal. However, the height of the supporting rod 4 may be changed in combination of the angle adjustment. In this case, the fine tuning of the resonance frequency and the bandwidth can be performed more efficiently by adjusting the amount of separation (distance) between the superconducting resonator pattern 2 and the anisotropic dielectric block 3. To realize such efficient tuning, a height adjusting mechanism for controlling the height of the support rod 4 is required in combination with the angle adjusting mechanism 15. By replacing the support rod 4 with a screw-type trimmer, the height adjusting function can be easily incorporated in the angle adjusting mechanism 15.

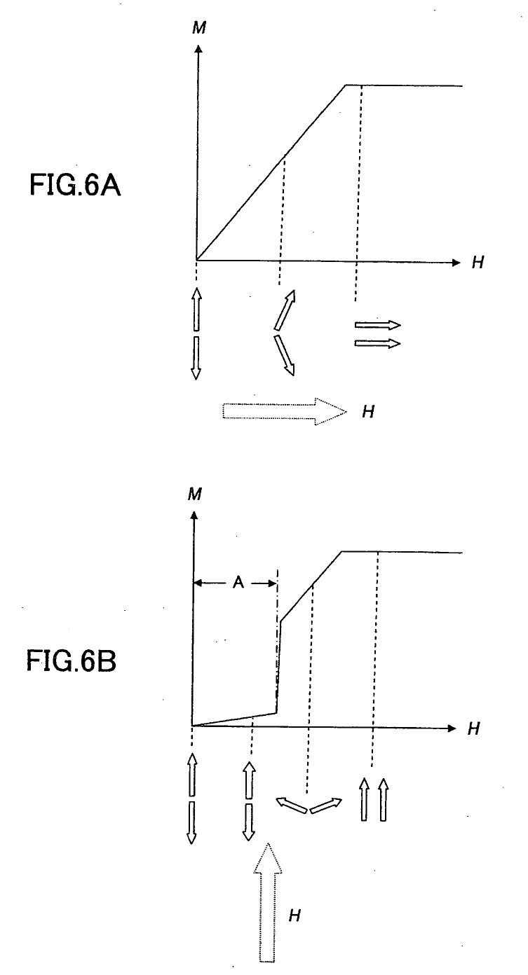

FIG. 6A and FIG. 6B are graphs for explaining the change in magnetic permeability for the input signal when an anisotropic magnetic block 3 is used in the superconducting filter device 10 shown in FIG. 1B. In this example, an antiferromagnet is used as the anisotropic magnetic block 3. Examples of antiferromagnets include Cr2O3, BiFeO3, and other suitable materials. FIG. 6A shows magnetization when a magnetic field H is applied in the lateral direction in the drawing sheet, and FIG. 6B shows magnetization when a magnetic field H is applied in the vertical direction in the drawing sheet. The horizontal axis of the graph represents the magnitude of the magnetic field H, and the vertical axis represents the magnitude of the magnetization M. The slope of the graph corresponds to permeability.

In an antiferromagnet, adjacent spins are headed in the opposite directions from each other without application of an external magnetic field (H=0). If a magnetic field is applied in the direction perpendicular to the spin, the magnitude of magnetization is in proportion to the applied magnetic field H, and the direction of magnetization is represented by the sum of the directions of the external magnetic field and the internal magnetic field induced by sublattice magnetization of spins other than the focused-on spin. If the energy of the applied magnetic field H exceeds the anisotropic energy of the spins, the entirety of spins orients to the direction of the external magnetic field.

If an external magnetic field is applied in the direction parallel to the spins, little magnetization is observed in range A in which the energy of the external magnetic field does not exceed the anisotropic energy of spins. In other words, the magnetic permeability varies greatly in the range of small magnitude of the external magnetic field, depending on the direction of the external magnetic field, perpendicular or parallel to the sublattice magnetization of spins. In general, the magnitude of the magnetic field H of the input signal is very small. Consequently, the permeability can be efficiently changed by controlling the angle or the orientation of the anisotropic magnetic block 3 with respect to the input signal.

Using an antiferromagnet is advantageous, as compared with typical ferromagnetic substances, because the influence of magnetic field leakage on the superconductor can be prevented. In place of the antiferromagnet, a material containing iron atoms may be used as the anisotropic magnetic body.

From the foregoing, the resonance frequency and/or the bandwidth of a superconducting filter device can be tuned at high precision, and a desired filter characteristic can be obtained. Because of the simple structure, the fabrication yield is improved and the scope of industrial application (including tunable filters) is expanded.

Although the invention has been described using specific examples, the invention is not limited to the examples. For example, an arbitrary superconducting oxide material may be used, in place of the YBCO thin film, to form a resonator pattern. Such superconducting oxide materials include, but are not limited to, a RBCO (R—Ba—Cu—O) material in which Nd, Sm, Gd, Dy, or Ho is used as the R element in place of ittoyttrium (Y). In addition, BSCCO (Bi—Sr—Ca—Cu—O) based materials, PBSCCO (Pb—Bi—Sr—Ca—Cu—O) based materials, CBCCO (Cu—Baₚ—Ca_{q}—Cuᵣ—Oₓ, 1.5<p<2.5, 2.5<q<3.5, 3.5<r<4.5) based materials may also be used as the superconducting material.

The dielectric base 1 on which the superconducting resonator pattern 2 is arranged is not limited to the MgO single crystal substrate used in the embodiment. A LaAlO3 substrate, a sapphire substrate, and any other suitable dielectric material may be used.

Similarly, the angle adjusting mechanism is not limited to a rotating mechanism making use of a piezoelectric element. For example, a motor-driven rotating mechanism, a hand-operated rotating mechanism, or an arbitrary mechanism capable of changing the horizontal angle or the orientation of the anisotropic dielectric or magnetic block with respect to the input signal may be employed.

The supporting rod 4 may be replaced with an arbitrary supporting means as long as the anisotropic dielectric or magnetic body is held in a secure and stable manner.

This patent application is based upon and claims the benefit of the earlier filing dates of Japanese Patent Application No. 2007-001020 filed Jan. 9, 2007, the entire contents of which are incorporated herein by reference.

What is claimed is:

1. A superconducting filter device comprising:
a dielectric base;
a resonator pattern formed of a superconducting material on the dielectric base;
an anisotropic dielectric or magnetic body positioned over the resonator pattern; and
an angle adjusting mechanism for changing a horizontal angle of the anisotropic dielectric or magnetic body with respect to an input signal.

2. The superconducting filter device of claim 1, wherein a piezoelectric element is used for the angle adjusting mechanism.

3. The superconducting filter device of claim 1, further comprising:
a mechanism for changing a gap between the anisotropic dielectric or magnetic body and the resonator pattern.

4. The superconducting filter device of claim 1, wherein the angle adjusting mechanism includes supporting means configured to hold the anisotropic dielectric or magnetic body over the resonator pattern.

5. The superconducting filter device of claim 4, wherein the supporting means is a supporting rod that rotatably holds the anisotropic dielectric or magnetic body such that the anisotropic dielectric or magnetic body is rotated with respect to the input signal in a horizontal plane.

6. The superconducting filter device of claim 4, wherein the supporting means is a supporting rod that holds the anisotropic dielectric or magnetic body movably in a vertical direction with respect to the resonator pattern such that the gap between the anisotropic dielectric or magnetic body and the resonator pattern changes.

7. The superconducting filter device of claim 1, wherein the anisotropic dielectric or magnetic body is an anisotropic dielectric block formed of a single crystal material selected from a group of LiNbO3, LiTaO3, BaB2O4, YbO4, TiO2, CaCO3, KTiOPO4, LiB3O5, KH2PO4, LiIO3, and sapphire, or a polarized polycrystalline material.

8. The superconducting filter device of claim 1, wherein the anisotropic dielectric or magnetic body is an anisotropic magnetic block formed of an antiferromagnetic material or an iron-atom containing material.

9. The superconducting filter device of claim 8, wherein the antiferromagnetic material includes Cr2O3 and BiFeO3.

10. The superconducting filter device of claim 1, wherein the angle adjusting mechanism includes a piezoelectric element, a driving plate pressed against the piezoelectric element, and a supporting rod extending from the driving plate to hold the anisotropic dielectric or magnetic body, and wherein the driving plate conveys a displacement generated in the piezoelectric element as a torque to the supporting rod.

11. A filter characteristic tuning method comprising the steps of:
arranging an anisotropic dielectric or magnetic body over a resonator pattern of a superconducting filter device; and
changing a horizontal angle of the anisotropic dielectric or magnetic body with respect to an input signal to tune a resonance frequency and/or a bandwidth for the input signal.

12. The filter characteristic tuning method of claim 11, wherein the anisotropic dielectric or magnetic body is held over the resonator pattern using supporting means, and the horizontal angle of the anisotropic dielectric or magnetic body is changed with respect to the input signal by rotating the supporting means.
